(19) United States
(12) Patent Application Publication
(10) Pub. No.: US 2006/0031469 A1
(43) Pub. Date: Feb. 9, 2006

(54) Measurement, reporting, and management of quality of service for a real-time communication application in a network environment

(75) Inventors: Michael Wade Clarke, Cary, NC (US); Stig Arne Olsson, Apex, NC (US); Ralph John Potok, Cary, NC (US); Geetha Vijayan, Austin, TX (US)

Correspondence Address: IBM CORP. (WIP);c/o WALDER INTELLECTUAL PROPERTY LAW, P.C., P.O. BOX 832745, RICHARDSON, TX, 75083, US

(73) Assignee: International Business Machines Corporation, Armonk, NY (US)

(21) Appl. No.: 10/880,275

(22) Filed: Jun. 29, 2004

(51) Int. Cl. G06F 15/173

(52) U.S. Cl. 709/224

(57) ABSTRACT

An example of a solution provided here comprises providing a measurement process including: (a) transmitting a test stream over a transmission path; and (b) measuring a quality-of-service indicator for a real-time communication application based on the transmitting; utilizing the measurement process, in continuously sampling a plurality of transmission paths in the real-time communication application's production environment; collecting data from the measurement process; comparing measured values to a threshold value; outputting a representation of compliance or non-compliance with the threshold value; and outputting a trend report based on the data; whereby the real-time communication application may be managed with reference to the threshold value. Such a solution may be selected for a Voice-over-Internet-Protocol application, a video conference application, or a speech-recognition application, to give some non-exclusive examples. One such example comprises measuring a speech-quality indicator for a Voice-over-Internet-Protocol application.

### CROSS-REFERENCES TO RELATED APPLICATIONS, AND COPYRIGHT NOTICE

The present patent application is related to co-pending patent applications: Method and System for Probing in a Network Environment, application Ser. No. 10/062,329, filed on Jan. 31, 2002, Method and System for Performance Reporting in a Network Environment, application Ser. No. 10/062,369, filed on Jan. 31, 2002, End to End Component Mapping and Problem—Solving in a Network Environment, application Ser. No. 10/122,001, filed on Apr. 11, 2002, Graphics for End to End Component Mapping and Problem—Solving in a Network Environment, application Ser. No. 10/125,619, filed on Apr. 18, 2002, E-Business Operations Measurements, application Ser. No. 10/256,094, filed on Sep. 26, 2002, E-Business Competitive Measurements application Ser. No. 10/383,847, filed on Mar. 6, 2003, and E-Business Operations Measurements Reporting, application Ser. No. 10/383,853, filed on Mar. 6, 2003. These co-pending patent applications are assigned to the assignee of the present application, and herein incorporated by reference. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to measuring or testing of digital communications, and more particularly to audio or video quality in real-time communications, such as methods and systems of evaluating speech, audio or video quality in a network environment.

### BACKGROUND OF THE INVENTION

Real-time communication applications may use networks that also transport data for other applications. This integration creates challenges. Real-time communication applications are sensitive to problems that commonly occur in data networks, such as packet loss or transport delay. These problems tend to cause unsatisfactory results for users of real-time communication applications (such as applications for telephone service, wireless voice communications, video conferences, speech-recognition, or transmitting live audio or video programming). These applications may involve many hardware and software components in a network environment. There is a need for information to properly focus problem—solving and ongoing management of these applications. Measurements provide a starting point (for example, measuring network performance, or results perceived by end users).

Tools to measure speech quality exist in the market place for example, but these do not provide a comprehensive solution. Existing tools do not necessarily provide for useful comparisons and management. Thus there is a need for a comprehensive approach to measurement, reporting, and management of quality of service for real-time communication applications.

### SUMMARY OF THE INVENTION

An example of a solution to problems mentioned above comprises providing a measurement process including: (a) transmitting a test stream over a transmission path; and (b) measuring a quality-of-service indicator for a real-time communication application based on the transmitting; utilizing the measurement process, in continuously sampling a plurality of transmission paths in the real-time communication application's production environment; collecting data from the measurement process; comparing measured values to a threshold value; outputting a representation of compliance or non-compliance with the threshold value; and outputting a trend report based on the data; whereby the real-time communication application may be managed with reference to the threshold value. Such a solution may be selected for a Voice-over-Internet-Protocol application, a video conference application, or a speech-recognition application, to give some non-exclusive examples. One such example comprises measuring a speech-quality indicator for a Voice-over-Internet-Protocol application.

### BRIEF DESCRIPTION OF THE DRAWINGS

A better understanding of the present invention can be obtained when the following detailed description is considered in conjunction with the following drawings. The use of the same reference symbols in different drawings indicates similar or identical items.

FIG. 1 illustrates a simplified example of a computer system capable of performing the present invention.

FIGS. 2A and 2B together form a block diagram, showing an example of a method and system of quality assurance in a network environment.

FIG. 3 illustrates an example of a report with data and statistics, resulting from measuring speech quality in telephone service that utilizes VoIP.

FIG. 4 shows an example of a trend report, based on weekly averages of speech quality values.

FIGS. 5A and 5B together form a block diagram, showing another example of a method and system of quality assurance, including end-to-end management.

### DETAILED DESCRIPTION

The examples that follow involve the use of one or more computers and one or more communications networks. The present invention is not limited as to the type of computer on which it runs, and not limited as to the type of network used. The present invention is not limited as to the type of medium or format used for output. Means for providing graphical output may include printing images or numbers on paper, displaying images or numbers on a screen, or some combination of these, for example.

The following are definitions of terms used in the description of the present invention and in the claims:

“About,” with respect to numbers, includes variation due to measurement method, human error, statistical variance, rounding principles, and significant digits.

“Application” means any specific use for computer technology, or any software that allows a specific use for computer technology.

“Call path” means a transmission path for telephone service.

“Comparing” means bringing together for the purpose of finding any likeness or difference, including a qualitative or quantitative likeness or difference. “Comparing” may involve answering questions including but not limited to: “Is a measured value greater than a threshold value?” Or “Is a first measured value significantly greater than a second measured value?”

“Component” means any element or part, and may include elements consisting of hardware or software or both.

“Computer-usable medium” means any carrier wave, signal or transmission facility for communication with computers, and any kind of computer memory, such as floppy disks, hard disks, Random Access Memory (RAM), Read Only Memory (ROM), CD-ROM, flash ROM, non-volatile ROM, and non-volatile memory.

“Measuring” means evaluating or quantifying; the result may be called a “Measure” or “Measurement”.

“Output” or “Outputting” means producing, transmitting, or turning out in some manner, including but not limited to printing on paper, or displaying on a screen, writing to a disk, or using an audio device.

“Production environment” means any set of actual working conditions, where daily work or transactions take place.

“Quality-of-service indicator” means any indicator of the results experienced by an application's end user; this may include an audio-quality indicator, speech-quality indicator, or a video-quality indicator, for example.

“Sampling” means obtaining measurements.

“Service level agreement” (or “SLA”) means any oral or written agreement between provider and user. For example, “service level agreement” includes but is not limited to an agreement between vendor and customer, and an agreement between an information technology (IT) department and an end user. For example, a “service level agreement” might involve one or more applications, and might include specifications regarding availability, quality, response times or problem-solving.

“Statistic” means any numerical measure calculated from a sample.

“Storing” data or information, using a computer, means placing the data or information, for any length of time, in any kind of computer memory, such as floppy disks, hard disks, Random Access Memory (RAM), Read Only Memory (ROM), CD-ROM, flash ROM, non-volatile ROM, and non-volatile memory.

“Test stream” means any packets, signals, or network traffic used for purposes of measuring or testing.

“Threshold value” means any value used as a borderline, standard, or target; for example, a “threshold value” may be derived from customer requirements, corporate objectives, a service level agreement, industry norms, or other sources

“Transmission path” means any path between a transmitter and receiver. It may be defined generally in terms of end points, not necessarily a specific path that packets take through a network.

“Trend report” means any representation of data or statistics concerning some period of time; it may for example show how an application performs over time.

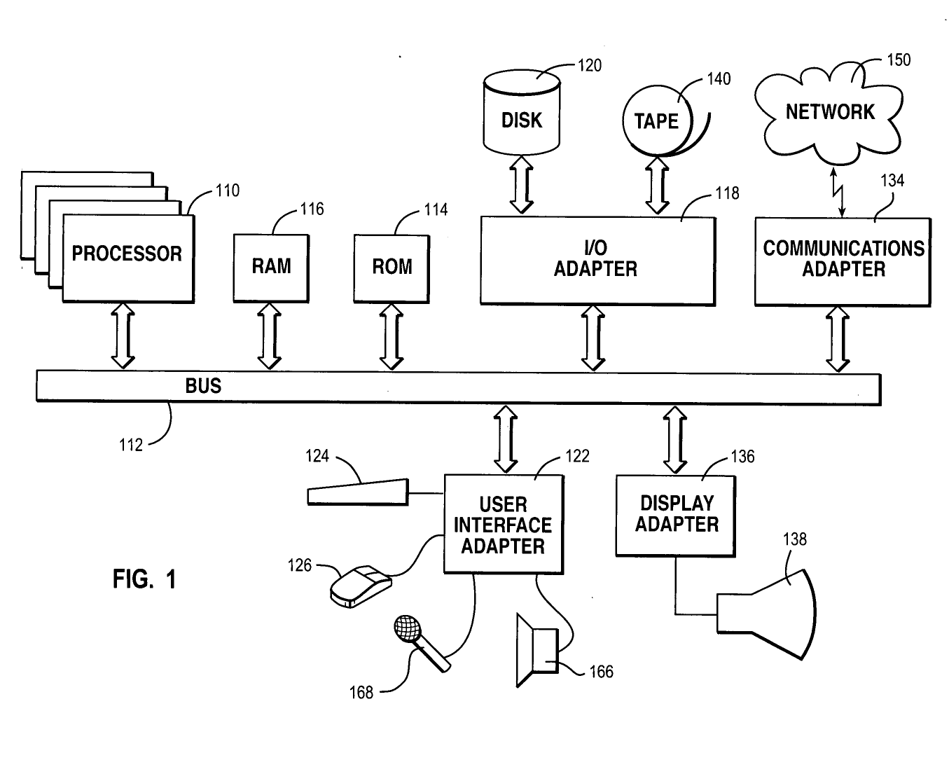

FIG. 1 illustrates a simplified example of an information handling system that may be used to practice the present invention. The invention may be implemented on a variety of hardware platforms, including embedded systems, personal computers, workstations, servers, and mainframes. The computer system of FIG. 1 has at least one processor 110. Processor 110 is interconnected via system bus 112 to random access memory (RAM) 116, read only memory (ROM) 114, and input/output (I/O) adapter 118 for connecting peripheral devices such as disk unit 120 and tape drive 140 to bus 112. The system has user interface adapter 122 for connecting keyboard 124, mouse 126, or other user interface devices such as audio output device 166 and audio input device 168 to bus 112. The system has communication adapter 134 for connecting the information handling system to a communications network 150, and display adapter 136 for connecting bus 112 to display device 138. Communication adapter 134 may link the system depicted in FIG. 1 with hundreds or even thousands of similar systems, or other devices, such as remote printers, remote servers, or remote storage units. The system depicted in FIG. 1 may be linked to both local area networks (sometimes referred to as intranets) and wide area networks, such as the Internet.

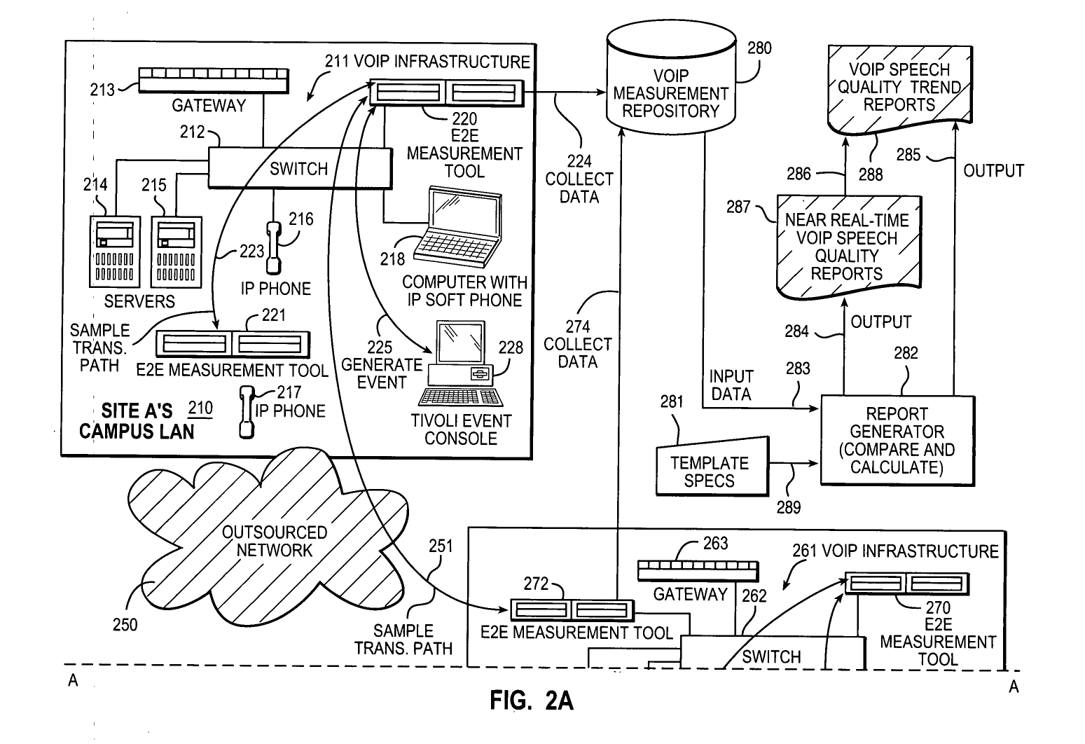

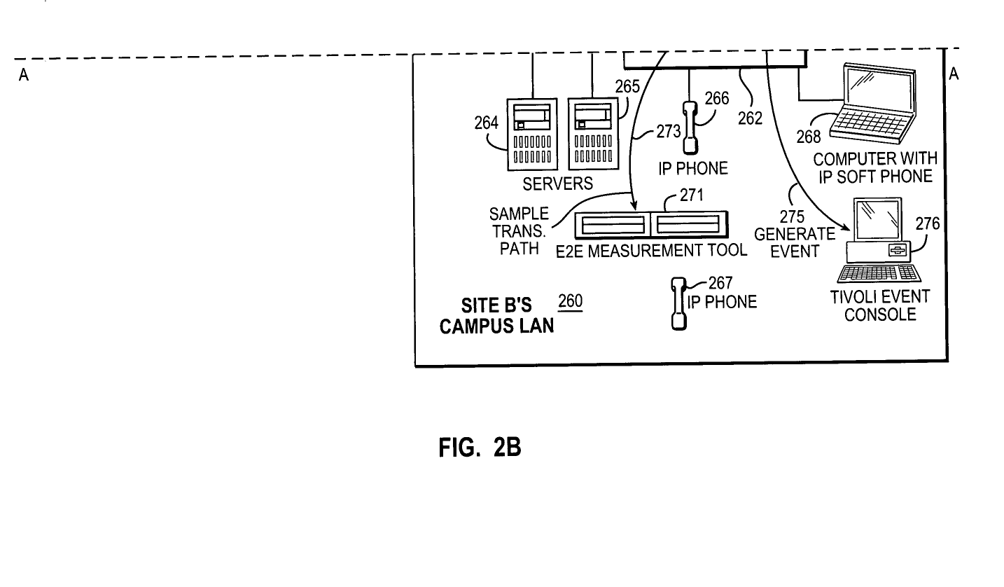

While the computer system described in FIG. 1 is capable of executing the processes described herein, this computer system is simply one example of a computer system. Those skilled in the art will appreciate that many other computer system designs are capable of performing the processes described herein. FIG. 1 represents an example of a computer that could be used to implement components in FIG. 2A (described below), such as end-to-end (E2E) measurement tools shown at 220 and 221, servers 214 and 215, computer 218 with IP soft phone, and report generator 282.

FIGS. 2A and 2B together form a block diagram, showing an example of a method and system of quality assurance in a network environment. The broken line AA shows where the diagram is divided into two sheets.

Beginning with a general view, FIGS. 2A and 2B may serve as an example of a method and system of quality assurance for any real-time communication application. The example involves providing a measurement process including: (a) transmitting a test stream over a transmission path (arrows 223, 251, and 273); and (b) measuring a quality-of-service indicator for a real-time communication application based on the transmission (symbolized by end-to-end (E2E) measurement tools shown at 220, 221, 270, 271 and 272).

The example involves utilizing the measurement process, in continuously sampling a plurality of transmission paths (arrows 223, 251, and 273) in the real-time communication application's production environment (local area network (LAN) 210, LAN 260, and network 250); collecting data (arrows 224 and 274) from the measurement process; comparing measured values to a threshold value (at 282); outputting (arrows 284 and 285) data and a representation (287) of compliance or non-compliance with the threshold value; and outputting a trend report 288 based on the data. The real-time communication application may be managed with reference to the threshold value. The example involves providing a measurement policy for the application (details below). A transmission path or a call path (arrows 223, 251, and 273) is defined generally in terms of end points, not necessarily a specific path that packets take through a network.

A method and system like the one shown in FIGS. 2A and 2B may involve any real-time communication application such as a Voice-over-Internet-Protocol application, a video conference application, or a speech-recognition application, for example. Computers 218 and 268 may be utilized in a video conference application, or a speech-recognition application, for example. Site A's campus local area network (LAN) 210 has typical infrastructure components including switch 212 and servers 214 and 215, for example. Voice-over-Internet-Protocol may be utilized for example, so Voice-over-Internet-Protocol (VoIP) infrastructure is shown at 211 and 261. Site A's campus LAN 210 has VoIP infrastructure at 211, including switch 212, gateway 213, IP phone 216, and servers 214 and 215, functioning as VOIP servers. Site B's campus LAN 260 has VoIP infrastructure at 261, including switch 262, gateway 263, IP phone 266, and servers 264 and 265, functioning as VoIP servers. In various examples, network 250 may represent a private network or the Internet.

End-to-end (E2E) measurement tools shown at 220, 221, 270, 271 and 272 measure indicators of quality from the end user's perspective. End-to-end measurements tend to involve multiple infrastructure elements. Measuring a quality-6f-service indicator may for example involve measuring an audio-quality indicator, or a video-quality indicator, or both. Measuring a quality-of-service indicator may involve one or more of the following, for example: utilizing perceptual evaluation of speech quality; measuring transport delay; and measuring packet loss. End-to-end measurement tools 220, 221, 270, 271 and 272 are connected by arrows 223, 251, and 273 that symbolize utilizing the measurement process, in continuously sampling transmission paths. The measurement process involves transmitting a test stream. Transmitting a test stream typically involves transmitting a reference file. Tool 220 may transmit a test stream to tool 221 (sampling path 223) or to tool 272 (sampling path 251). As another example, a test stream may be transmitted from tool 220 to computer 218 to switch 212, back to tool 220 (sampling a path within Site A's campus LAN 210). IP phones 217 and 218, shown without wires, may represent wireless telephones and the utilization of voice over a wireless local area network. Wireless communications may involve special problems such as limited bandwidth. Proper emulation of a wireless phone may require adjustment of the measurement process. For example, end-to-end measurement tool 221 may be equipped with a wireless connection to LAN 210.

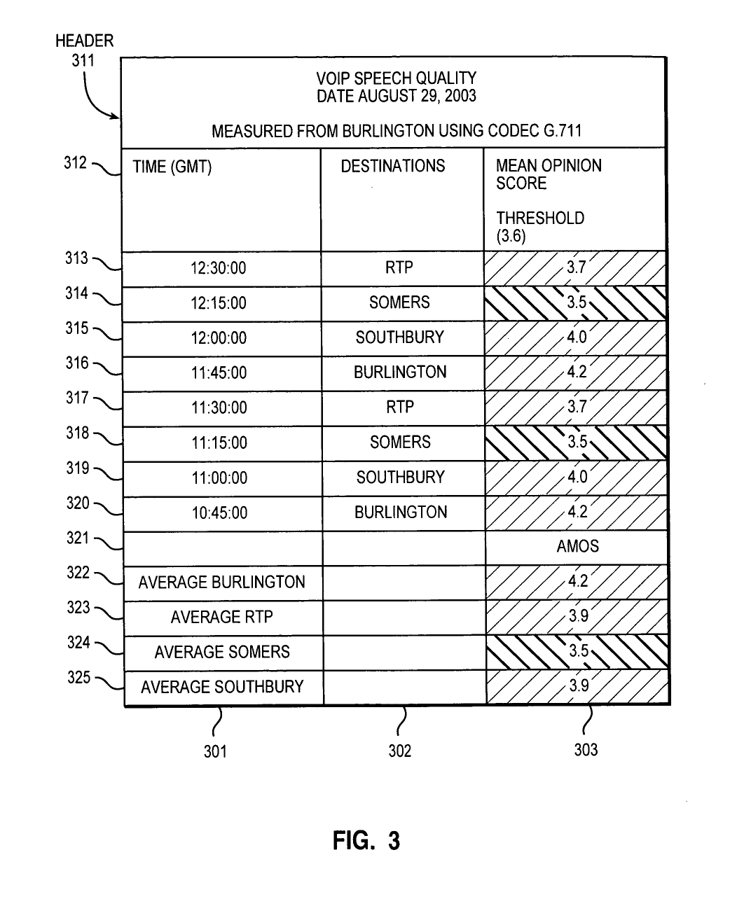

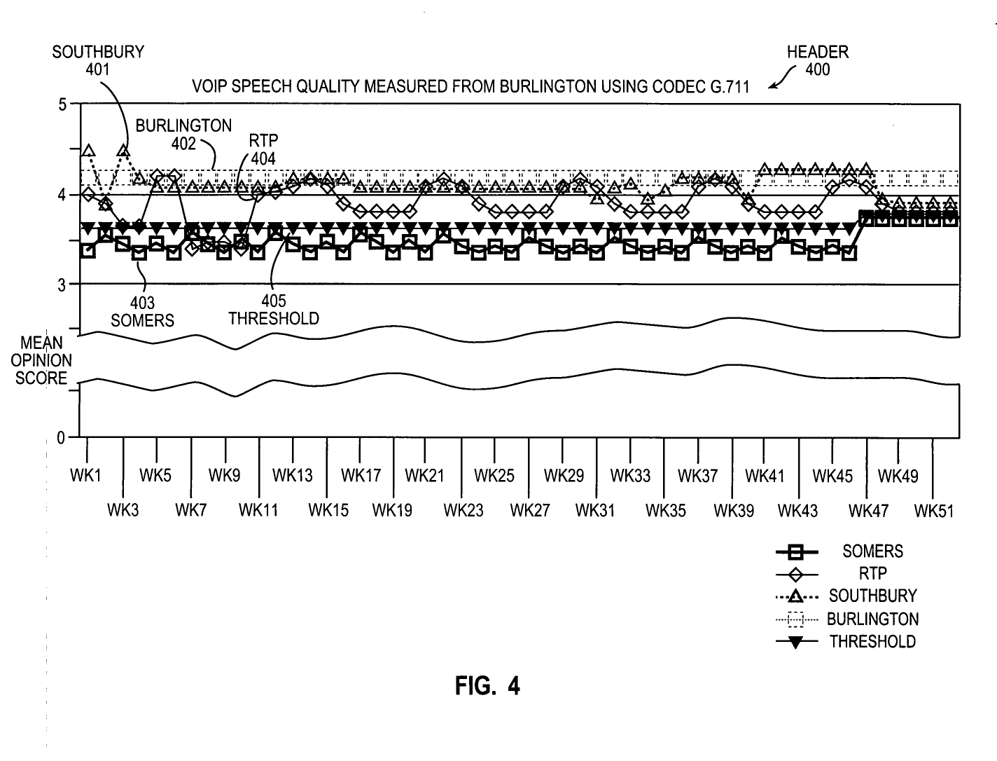

The example in FIGS. 2A and 2B involves collecting measurement data (arrows 224 and 274) in a repository (or database(s), at 280). Report generator 282 uses a template (symbolized by Template specs 281; also see FIG. 3) and data from repository 280 to generate near-real-time reports 287 on each application being evaluated. This information may be retrieved and summarized (symbolized by the arrow 286) to create trend reports 288 (see FIG. 4 as an example of a report symbolized by report 288 in FIGS. 2A and 2B.) Report generator 282 and measurement tools 220 symbolize both hardware and software. 15 The example in FIGS. 2A and 2B involves calculating statistics at 282, based on the data at 283; and outputting (284) the statistics, in reports 287 and 288.

The example in FIGS. 2A and 2B involves providing an alert via a system-management computer, when results indicate an error. Tool 220 generates a real time alert (problem event 225), and sends it to a TIVOLI management system (the software products sold under the trademark TIVOLI by IBM, shown as TIVOLI event console 228). FIG. 2B shows problem event 275, sent to TIVOLI event console 276. Another similar kind of management system could be used, such as the software product sold under the trademark HP OPENVIEW by Hewlett-Packard Co. An alert message via email also could be used. Comparing with thresholds and alerting may be performed at 282 or 220 for example.

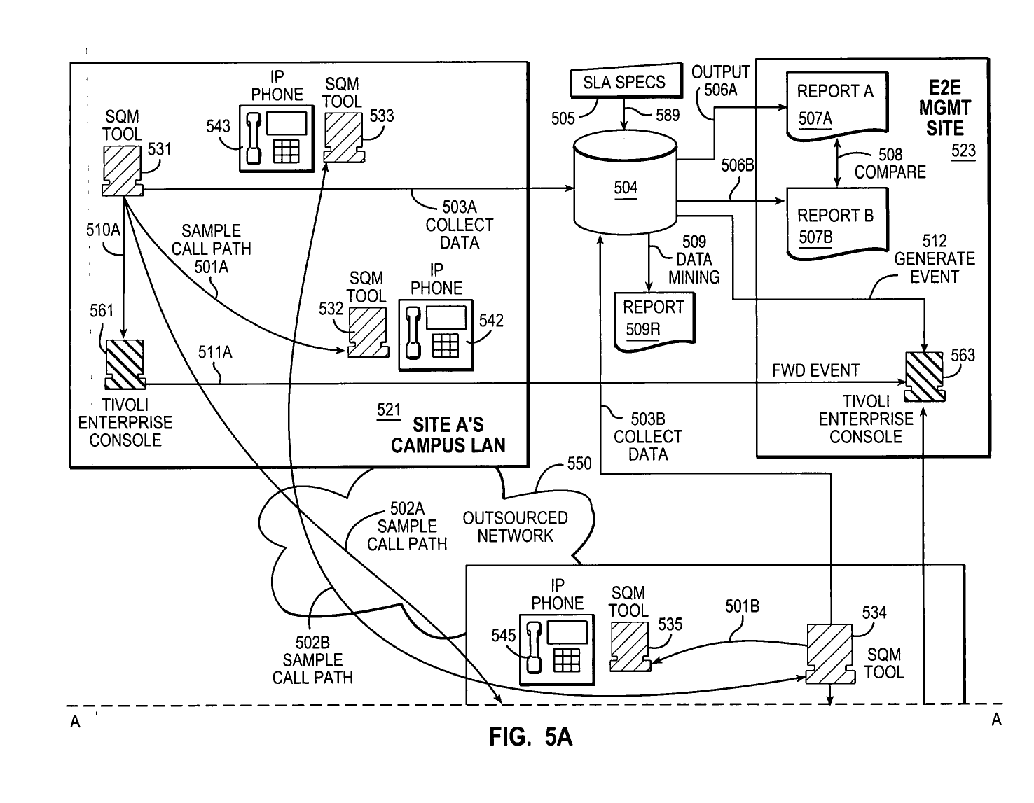

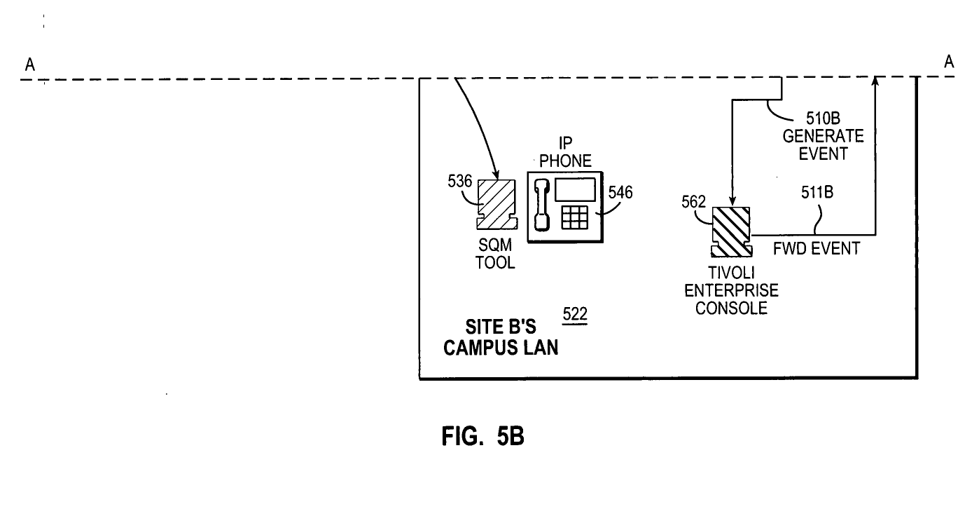

Concerning FIGS. 2A and 2B, consider providing a measurement policy for a real-time communication application. FIGS. 2A and 2B provide an example including VOIP, telephone communications, a measurement and reporting solution architecture, and guiding principals. FIGS. 2A and 2B may serve as a high level measurement and reporting solution architecture, to define a sample VOIP network environment with a subset of all IT infrastructure components and to show how end user speech quality is measured over the VOIP network. The scope of the example solution is speech quality experienced by the end user of VOIP services. The measurement data is obtained according to ITU standards for speech quality measurements. Data obtained by the measurement tool is forwarded to a VOIP measurement repository 280 for aggregation, comparison with speech quality thresholds and customized reporting (see description of data mining connected with FIG. 5A). From the VOIP measurement repository 280 it is possible to produce near real-time daily report 287 which is available on the web. Near time daily reports allows detection of quality problems before customer satisfaction is impacted. Consistent reports allow a company to compare different VOIP implementations provided by outside service providers. Also, the selected measurement tool (e.g. 220) preferably should have the capability to generate TIVOLI events (225) when speech quality thresholds are exceeded.

Here is an example of a measurement policy, expressed as requirements and guiding principals to ensure customer satisfaction:

1) Speech quality measurements are obtained from an end user perspective. Speech quality measurements should support international ITU-T recommendation P.862 which uses the PESQ (Perceptual Evaluation of Speech Quality) algorithm.

2) Standardized reporting is utilized to ensure consistency of how speech quality is reported. The report format is standardized to allow automation to reduce cost.

3) E2E end user speech quality events are integrated into existing TIVOLI management solutions and supporting processes such as problem and change management.

Sampling (Obtaining Measurements):

1. Measurements are obtained from an end user perspective. In order to properly emulate the end user environment the codec used in the end user phone is supported.

2. All speech quality measurements are taken on a 7×24 basis excluding scheduled network down time.

3. A sampling interval of about 1 hour is utilized, per destination location.

4. The measurement tool is able to retry a test stream where the threshold was exceeded.

5. The service delivery center (data center) has the responsibility to ensure the integrity of the measurement and reporting solution.

6. The measurement solution is able to generate TIVOLI events if a speech quality threshold is exceeded.

7. TIVOLI events are integrated with the TIVOLI tools (TIVOLI Enterprise Console) used in the Service Delivery Centers (data centers).

8. The measurement tool selected and deployed is managed using appropriate TIVOLI solutions.

Reports and Access to Measurement Data:

1. The solution supports the ability to transport measurement data to a centrally located measurement repository to generate customized reports.

2. The solution is able to transport measurement data to a centrally located measurement repository near real time.

3. Retention of measurement data is for 90 days.

4. Reports are displayed in GMT

5. The service provider preferably should notify customers immediately when a data failure has occurred on the transport or the data is in corrupted.

6. The solution preferably should provide the transported data in GMT time.

7. The solution includes security measures to ensure that report data and transported data are not compromised.

8. The service provider preferably should inform the customers of any changes to the measurements and transported data.

Near Real-Time Daily Measurement Report:

This report (287) is produced daily on the web for easy access by the customers. It is used to get a detailed view of end user speech quality for the selected set of customer call paths (i.e. transmission paths). This report can be used as a vehicle to identify problem areas and speech quality trends on a daily basis. The report has one row for each measurement where the key measurement is the calculated Mean Opinion Score (MOS) score for a test stream. (See also FIG. 3 for a detailed example.) The report represents different types of call paths, such as local call paths, between two parties in the same site (e.g. arrow 223 within Site A), or call paths between two parties in two physically different sites (e.g. arrow 251 between Site A and Site B), where the IP packets are routed over the outsourced network 250.

FIGS. 2A and 2B may serve as an example of a system of quality assurance. E2E measurement tools 220, 221, 270, and 271 represent means for transmitting a test stream over a transmission path; means for measuring a quality-of-service indicator for a real-time communication application based on the transmission; and means for continuously sampling a plurality of transmission paths in the real-time communication application's production environment. E2E measurement tools 220, 221, 270, and 271 represent means for sampling a transmission path within a site (e.g. arrow 223 within Site A); and means for sampling a transmission path between sites (e.g. arrow 251 between Site A and Site B). This involves the placing and programming of E2E measurement tools 220, 221, 270, and 271. E2E measurement tools 220, 221, 270, and 271 may be adapted (with an appropriate chip or software) to various kinds of real-time communication applications, such as a Voice-over-Internet-Protocol application, a video conference application, and a speech-recognition application, for example. The means for measuring a quality-of-service indicator may comprise one or more of the following for example: means for utilizing perceptual evaluation of speech quality; means for measuring transport delay; and means for measuring packet loss. The means for transmitting a test stream may comprise means for transmitting a reference file. E2E measurement tools 220, 221, 270, and 271 may include means for comparing measured values to a threshold value.

E2E measurement tools 220, 221, 270, and 271 may be implemented in various ways. One example uses measurement tools sold under the trademark OPTICOM by Opticom Instruments Inc., Los Altos, Calif., for example. Measurement tools from Opticom Instruments Inc. are described in a white paper by Opticom Instruments, Voice Quality Testing for Wireless Networks, 2001 (herein incorporated by reference) and in a white paper by Opticom Instruments, Voice Quality in IP Networks, 2002 (herein incorporated by reference), both available from the web site of Opticom Instruments Inc. Voice Quality Testing for Wireless Networks describes measurement techniques, such as utilization of a reference file: “the reference file should be a signal that comes as close as possible to the kind of signal which shall be applied to the device under test in real life. If e.g. you design a special headset for female call center agents, you should use a test stimulus which contains mostly female speech . . . for the transmission of high quality music between broadcast studios, you should test your device with real music.” That paper describes various perceptual audio measurement algorithms for speech and music signals, especially the algorithm known as Perceptual evaluation of speech quality (PESQ) utilized by tools from Opticom Instruments.

A publication of the International Telecommunications Union, Perceptual evaluation of speech quality (PESQ) an objective method for end-to-end speech quality assessment of narrowband telephone networks and speech codecs, Recommendation P.862, 2001, is herein incorporated by reference. Recommendation P.862 describes an objective method for predicting the subjective quality of 3.1 kHz (narrow-band) handset telephony and narrow-band speech codecs. Recommendation P.862 includes a high-level description of the method, and an ANSI-C reference implementation of PESQ.

Other measurement tools are described in an article by Michael Larson, “Probing Network Characteristics: A Distributed Network Performance Framework,” Dr. Dobb's Journal, June 2004, herein incorporated by reference. Larson's framework allows one to diagnose and act on network events as they occur. The framework may be implemented with computers running any of a large variety of operating systems. The source code is available from the web site of Dr. Dobb's Journal. One of Larson's examples is a tool for measuring delay in the transport of a packet. (Real-time communication applications such as Voice-Over-IP are sensitive to delays.) Another of Larson's examples is an email notification, performed as an action in response to certain network event.

Other measurement tools are described in an article by Vilho Raisanen, “Quality of Service & Voice-Over-IP,” Dr. Dobb's Journal, May 2001, herein incorporated by reference. Raisanen describes an implementation of a system for active measurement with a stream of test packets, suitable for media emulation, implemented with personal computers running the operating system sold under the trademark LINUX. The source code is available from the web site of Dr. Dobb's Journal. Raisanen points out that important requirements for transport of VoIP are: “End-to-end delay is limited and packet-to-packet variation of delay (delay jitter) is bounded. Packet loss percentage falls within a certain limit and packet losses are not too correlated.” Raisanen's system performs measurements relevant to these requirements.

VOIP measurement repository 280 represents means for collecting data from the measurement process. Arrows 224 and 274 symbolize collecting, via a network, the data produced by the measuring process. The database or repository 280 may be implemented by using software products sold under the trademark DB2 by IBM for example, or other database management software products sold under the trademarks ORACLE, INFORMIX, SYBASE, MYSQL, SQL SERVER, or similar software. The repository 280 may be implemented by using software product sold under the trademark TIVOLI DATA WAREHOUSE by IBM for example. TIVOLI DATA WAREHOUSE allows customers to get cross-application reports from various applications (TIVOLI's applications or customers' applications). Repository 280 may include means for adjusting the threshold value. Threshold values may be defined in repository 280.

Report generator 282 represents means for comparing measured values to a threshold value; means for outputting a representation of compliance or non-compliance with the threshold value (in report 287 or 288); and means for outputting a trend report 288 based on the data. An automated reporting tool (shown as report generator 282) runs continuously at set intervals, obtains data 283, from database 280, and posts on a web site report 287. Report 287 also could be provided via email at the set intervals. Report generator 282 may be implemented by using the Perl scripting language and a computer running the operating system sold under the trademark AIX by IBM, for example. However, some other programming language could be used, and another operating system could be used, such as software products sold under the trademarks LINUX, or UNIX, or some version of software products sold under the trademark WINDOWS by Microsoft Corporation, or some other operating system. Report generator 282 may include means for calculating statistics, based on the data; and means for outputting the statistics.

FIG. 3 illustrates an example of a report with data and statistics, resulting from measuring speech quality in telephone service that utilizes VoIP. Similar reports could be produced in connection with other kinds of applications. A report like this may be produced each day. Rows of data have been omitted from this example, to make the size of the diagram manageable. Note that the example shown in FIG. 3 involves reporting results of each transmission of a test stream (in Rows 313-320). This is an example of comprehensive reporting, rather than displaying only summaries or averages. Reporting results of each transmission of a test stream allows immediate recognition of problems, and provides guidance for immediate problem-solving efforts.

This kind of report preferably is provided daily on the web for easy access by the customers. It is used to get a detailed view of end user speech quality for the selected set of customer call paths (in Column 302). This report can be used as a vehicle to identify problem areas and speech quality trends on a daily basis. The report has one row for each measurement (each transmission of a test stream in Rows 313-320) where the key measurement is the calculated Mean Opinion Score (MOS) for a test stream. This speech-quality indicator is a measurement of perceptual speech; quality. The report represents different types of call paths, such as local call paths, between two parties in the same site (e.g. within Burlington, row 316), or call paths between two parties in two physically different sites (e.g. between Burlington and Somers, row 314). Column 302 shows a call path to a site as a call destination. Thus FIG. 3 is an example of sampling a plurality of call paths between sites, and outputting a representation of a plurality of call paths from a first site to other sites.

The header 311 of the report includes basic information such as the location from which these measurements were taken and which codec was used to measure speech quality. Rows 313-320 are time stamped and time is reported in Greenwich Mean Time (GMT, see Row 312). The Mean Opinion Score (MOS) is calculated using the ITU-T Recommendation P.862's Perceptual Evaluation of Speech Quality algorithm.

This example involves comparing data and statistics with threshold values. To report the results of this comparing, color is used in this example. The speech quality measurement, expressed as a Mean Opinion Score, is measured against a SLA value or threshold. In the example the threshold has been set to 3.6. (The cell at column 303, Row 312 shows a threshold value of 3.6.) This threshold is modifiable so adjustments can be made as we learn what is acceptable to the end users in our environments. The MOS score is the primary metric to ensure that customer satisfaction is not impacted by the transition from plain old telephone service to VOIP solutions, for example. Preferably, the cell background is colored green if the measured MOS score is equal to or above the established threshold. If the measured MOS score is below the threshold the cell is colored red. Column 301 shows time of test stream transmission. Each row from row 313 downward to row 320 represents one iteration of the test stream transmission; each of these rows represents an end user's perception of speech quality in a telephone call. In Column 303, a speech-quality indicator is compared with a corresponding threshold value. To report the results of this comparing, using a color code, a special color is shown by darker shading, seen in the cell at column 303, row 314. This example involves outputting in a special mode any measured speech-quality value that is less than the corresponding threshold value (in other words, outputting in a special mode a representation of non-compliance with the threshold value). Outputting in a special mode may mean outputting in a special color, (e.g. the special color may be red), or outputting with some other visual cue such as highlighting or a special symbol.

Continuing with details of FIG. 3, this example involves calculating and outputting statistics. In each of rows 322-325, a statistic is aligned with a corresponding threshold value in column 303. Rows 322-325 display average speech-quality values (indicated by Average Mean Opinion Score (AMOS) at row 321, column 303). This statistic involves calculating an average speech-quality value, and outputting the average speech-quality value (in column 303). The AMOS value is calculated per destination on the daily report. The AMOS value is used to produce a quality of service trend report (see FIG. 4). This example also involves comparing the average speech-quality value with a corresponding threshold value (The cell at column 303, Row 312 shows a threshold value of 3.6); and reporting the results (in column 303) of the comparison. This example also involves outputting in a special mode (in column 303) the average speech-quality value when it is less than the corresponding threshold value. Outputting in a special mode may mean outputting in a special color or outputting with some other visual cue as described above. If the AMOS value is equal to or above the established threshold, preferably the cell is colored green. If it is below the established threshold the cell is red. This example involves comparing results expressed as a mean opinion score, to a threshold value expressed as a mean opinion score. Threshold values may be derived from a service level agreement [SLA], or from sources such as customer requirements, standards for quality, or corporate objectives for example.

A report like the example in FIG. 3, including the representation of compliance or non-compliance with a threshold value, may be utilized in managing the operation of the real-time communication application. One useful technique is comparing results for the transmission path within a site (e.g. within Burlington, at rows 316 and 320) to results for the transmission path between sites (such as between Burlington and Research Triangle Park (RTP), rows 313 and 317). Consider an example utilizing the report and representation of compliance or non-compliance in managing the operation of the real-time communication application. An information technology (IT) department may utilize the report and representation of compliance or non-compliance in evaluating new infrastructure components in the production environment (See also description of FIG. 4, below).

FIG. 4 shows an example of a trend report, based on weekly averages of speech quality values. These values may be taken from reports like the example in FIG. 3. This is an example of useful trend reporting, that shows how an application performs over time against a threshold value (shown by line 405). The example in FIG. 4 may involve measuring a quality of service indicator (such as mean opinion score, shown on the vertical axis), over a time period of at least several weeks (shown on the horizontal axis), and producing a trend report for the time period. This is another example of calculating statistics, based on the data; and outputting the statistics. A description of the measurement is shown in the header 400. The wavy lines just above zero on the vertical axis show where an empty portion of the graph is omitted from this example, to make the size of the diagram manageable.

The network infrastructure will evolve over time so preferably the method creates trend reports showing speech quality over an extended period of time. The weekly AMOS value (the average MOS score per destination, shown by lines 401, 401, 403, and 404) is used on the trend report in FIG. 4. The trend report may show the last year, for example (shown on the horizontal axis), and show the threshold MOS score (threshold 405). In another example, the daily AMOS value (the average MOS score per destination) may used on the trend report, which may show the last 90 days.

The trend report in FIG. 4 is used to discover positive and negative trends in end user perceived speech quality. If technically and financially justified, it is assumed that the threshold value will be modified over time. The trend report may be the basis for the establishment of new company standards, Service Level Agreements and thresholds. Thus the real-time communication application may be managed with reference to the threshold value. FIG. 4 shows an example of setting a new threshold value (shown by line 405, set at a higher level beginning in week 47); and managing the real-time communication application with reference to the new threshold value.

Similarly to FIG. 3, FIG. 4 shows an example of comparing results for the transmission path within a site (Burlington 402) to results for the transmission path between sites (such as between Burlington and Southbury 401). FIG. 4 also shows an example of sampling a plurality of call paths between sites, and outputting a representation of a plurality of call paths from a first site to other sites (such as from Burlington to Southbury 401, Somers 403, and RTP 404). The speech-quality indicator is a measurement of perceptual speech quality (mean opinion score, shown on the vertical axis). FIG. 4 involves comparing results (lines 401, 401, 403, and 404) expressed as a mean opinion score, to a threshold value 405 expressed as a mean opinion score.

Consider an example utilizing the report and representation of compliance or non-compliance with the threshold value, in managing the operation of the Voice-over-Internet-Protocol application. A chief information officer (CIO) may utilize the report and representation of compliance or non-compliance in FIG. 4, in evaluating new infrastructure components in the production environment. Utilizing the measurement process, a plurality of transmission paths are sampled in the production environment, and data is collected from the measurement process, for a period before new infrastructure components are installed. Then for a period after new infrastructure components are installed, data is collected from the measurement process again. Outputting a trend report like FIG. 4, based on the before-and-after data, allows the CIO to evaluate the investment in new infrastructure components. An increased frequency of compliance with the threshold value, after installation, may be evidence of a positive return on investment for the new infrastructure components. Thus the real-time communication application may be managed with reference to the threshold value 405.

FIGS. 5A and 5B together form a block diagram, showing another example of a method and system of quality assurance, including end-to-end management (symbolized by E2E Mgmt Site 523, with TIVOLI Enterprise Console 563). The broken line AA shows where the diagram is divided into two sheets. A voice-over-IP application's production environment includes Site A's campus LAN 521, outsourced network 550, and Site B's campus LAN 522. Site A's campus LAN 521 has IP phones 542 and 543, TIVOLI Enterprise Console 561, and speech quality measurement (SQM) tools 531, 532, and 533. Site B's campus LAN 522 has IP phones 545 and 546, TIVOLI Enterprise Console 562, and speech quality measurement (SQM) tools 534, 535, and 536.

501A: The measurement tools (531 and 532) emulate customer phone calls and measure speech quality using the PESQ (Perceptual Evaluation of Speech Quality) algorithm on the campus LAN 521.

502A: The measurement tools (531 and 536) emulate customer phone calls and measure speech quality using the PESQ (Perceptual Evaluation of Speech Quality) algorithm across an outsourced network 550.

503A: The measurement data is sent from the measurement device (531) to a data repository at 504.

504: The data repository at 504 is external to the measurement device and uses data base technology such as DB2. The data repository at 504 may be implemented by using TIVOLI DATA WAREHOUSE for example. TIVOLI DATA WAREHOUSE allows customers to get cross-application reports from various applications. The external database at 504 can accept data (503A and 503B) from multiple measurement devices (tools 531 and 534).

505: SLA specifications can be defined in the data repository at 504. Examples of SLA specifications are:

MOS threshold for the campus LAN.

MOS threshold for sampling using an outsourced network 550. This MOS threshold could be a component of an SLA with vendor.

506A and 506B: A report generator at 504 is used to create and output (506A and 506B) near real time daily detailed reports of the sampling from each location.

507A and 507B: The near time daily reports use the MOS score thresholds from the SLA specification (input symbolized by arrow 589 from SLA specifications 505). If the actual measurement is above or equal to the threshold the cell is green. If the measurement is below the threshold the cell is red. Producing this report near real time allows the operational staff to identify daily trends in speech quality. The daily report may reveal degradation of speech quality, for example due to load on the network. It may also reveal consistent problems where thresholds cannot be achieved, due to campus infrastructure (521 or 522) capacity or implementation problems.

508: Since this report is generated per campus, we can compare the reports to identify daily speech quality trends when using an outsourced network. If the local sampling in each campus achieve thresholds within a time interval, and remote sampling between the campuses fail to meet the thresholds, then it is likely that the outsourced network 550 is experiencing a problem.

509: Since the data is kept in an external data repository it is possible to do data mining of the collected measurement data. For example, variants of this daily report 509R may show local sampling over the day where measurements are compared to a site specific threshold. This could be used to measure quality impact based on level of utilization of the campus LAN over the day. It is also possible to generate report 509R where only measurements of inter campus test streams are included and these measurements could be compared to a separate threshold.

TIVOLI enterprise consoles at 561, 562, and 563 symbolize integration of quality measurements into an overall management system. The quality of service solution described here allows integration with existing management systems and organizations. We assume that problems are handled as close to the source as possible, but some events are forwarded to an organization with E2E responsibility (E2E management site 523).

510A: The measurement tool 531 performs speech quality measurements using the PESQ (Perceptual Evaluation of Speech Quality) algorithm on the campus LAN 521. If a threshold is exceeded, an event is generated and forwarded (510A) to the local TIVOLI Enterprise Console 561. This event notification can be accomplished if the measurement device 531 is able to use generally available TIVOLI Commands. The TIVOLI wpostemsg or postemsg can be used to send the event (510A) with customized message text and severity rating. An example is provided below: wpostemsg, -r WARNING -m “Quality problem detected when making local phone calls in Somers”.

This event is sent (510A) to the local TIVOLI Enterprise Console 561 used to manage the local IT environment. If a scheduled test stream fails and generates the WARNING event the measurement tool 531 should have the ability run another test stream. If this test stream is successful the WARNING event can be closed on the event console 561 by using a “HARMLESS” event.

511A: In a more advanced implementation, rules can be generated in the TIVOLI Enterprise Console 561 to forward the event (511A) to an organization with an E2E responsibility at 523. For example if we get two consecutive “WARNING” events we forward an event (511A) with a severity of “CRITICAL” and a customized message text: “Repeated Quality problems detected on local calls in Somers”.

Once the problem is resolved the “HARMLESS” event is used to close previously opened “WARNING” and “CRITICAL” events.

512: Depending on the size of the environment we may want to automate the comparison of measurements for selected call paths. Since the measurement data is stored in the data repository, a program can be developed to search the data base periodically. For example, the program uses parameters to identify the type of test streams to compare. Local test streams in two different campuses can be compared against their thresholds and compared with inter site test streams between the two locations. If the comparison indicates a quality problem between the sites, the program generates an event (512) to the TIVOLI Enterprise Console 563 used by the team managing the E2E solution. For example, wpostemsg, -r CRITICAL -m “Speech quality problem detected between Somers and Burlington”.

In other words, the example in FIGS. 5A and 5B involves utilizing a measurement process including: (a) transmitting a test stream over a call path (e.g. 501B or 502B) in a voice-over-IP application's production environment; (b) receiving the test stream (at measurement tool 532 for example); (c) measuring a speech-quality indicator (symbolized by measurement tool 531 and 532 for example) for the voice-over-IP application, based on the transmitting and receiving; (d) repeating the above three steps periodically.

The example continues: with the measurement process, sampling a call path within a site (e.g. 501B); with the measurement process, sampling a call path between sites (e.g. 502B); collecting data (e.g. 503A or 503B) from the measurement process, comparing results of the measuring to a threshold value; and outputting (506A or 506B) data and a representation (report 507A or report 507B) of compliance or non-compliance with the threshold value.

Tool 531 may transmit a test stream to tool 532 (sampling path 501A) or to tool 536 (sampling path 502A). As another example, a test stream may be transmitted from tool 532 to IP phone 542, and through LAN 521 back to tool 532 (sampling a path within Site A's campus LAN 521). Sampling a call path within a site (e.g. 501B) may involve any location having a population of end users. A report generator uses specifications (symbolized by “SLA specs” at 505) and creates reports (symbolized by reports 507A and 507 B). Reports from different sites or different call paths can be compared. (The double-headed arrow 508 symbolizes comparison.)

Such comparison provides direction for problem-solving and management. Data mining at 509 may involve receiving input specifying a call path of interest; retrieving stored data associated with the call path of interest; and comparing measured values to a unique threshold value, for the call path of interest; whereby data mining and evaluation are performed for the call path of interest. Data mining at 509 may involve receiving input identifying a call path within a first site, and a call path within a second site; retrieving stored data associated with the identified call paths; and comparing measured values to a threshold value, for each of the identified call paths; whereby data mining and evaluation are performed for the first site and the second site.

FIGS. 5A and 5B may serve as an example of a system of quality assurance, including means for providing an alert 511A, to an end-to-end management site 523, via a system-management computer 563, when results indicate an error. The system may comprise data mining means (e.g. data base management software or data mining software) at 504 for: receiving input specifying a transmission path of interest; retrieving stored data associated with the transmission path of interest; and comparing measured values to a unique threshold value, for the transmission path of interest. The system may comprise data mining means at 504 for: receiving input identifying a transmission path within a first site, and a transmission path within a second site; retrieving stored data associated with the identified transmission paths; and comparing measured values to a threshold value, for each of the identified transmission paths.

Concerning end-to-end management (E2E Mgmt) site 523, this may represent an organization with an end-to-end management responsibility. In one scenario, this organization may be the IT department for the owner of site A and Site B. This scenario involves sampling call paths 502A and 502B between company sites using an outsourced network. This measurement provides E2E speech quality between sites including the outsourced network. This measurement allows a company to determine that the outsourced network provides speech quality in accordance with the Service Level Agreement (SLA). On the other hand, consider sampling call paths 501A and 501B within a site. This measurement provides speech quality within a company campus/location. In addition, this measurement will assist in problem determination activities. Internal measurements can be compared with E2E speech quality measurements sampling call paths 502A and 502B, to determine where speech quality degradation is occurring. This will allow the owner of site A and Site B to engage the outsourced network provider faster for problem resolution activities when it is believed that quality degradation is occurring in the outsourced network 550.

In another scenario, end-to-end management (E2E Mgmt) site 523 may represent a service provider who provides integrated voice and data networks (LAN's 521 and 522) to the owner of site A and Site B. Perhaps this service provider also owns outsourced network 550. Having both inter campus (sampling call paths 502A and 502B) and intra campus (sampling call paths 501A and 501B) measurements enables this service provider to accomplish faster problem identification, thus reducing customer impact. For example, the service provider could identify performance degradation caused by a specific component. There is a degradation of service but telephone service is still available. Then the service provider may take proactive measures to avoid more serious problems.

This final portion of the detailed description presents some details of a working example implementation that was developed and deployed within IBM. Measurement, reporting and management of speech quality were implemented for telephone communications within and between IBM facilities, over integrated voice and data networks. This implementation was connected with a transition from traditional phone systems to Voice Over IP, and involved problem-solving and management functions. Speech quality measurement tools were implemented by using measurement tools from Opticom Instruments Inc., Los Altos, Calif., and the algorithm known as Perceptual evaluation of speech quality (PESQ). This example implementation was the basis for the simplified examples illustrated in FIGS. 2A-5B.

In summary, we provide here examples of a comprehensive quality assurance solution for real-time communications (audio and video). We provide a detailed example involving speech quality and VOIP.

One of the possible implementations of the invention is an application, namely a set of instructions (program code) executed by a processor of a computer from a computer-usable medium such as a memory of a computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus,.the present invention may be implemented as a computer-usable medium having computer-executable instructions for use in a computer. In addition, although the various methods described are conveniently implemented in a general-purpose computer selectively activated or reconfigured by software, one of ordinary skill in the art would also recognize that such methods may be carried out in hardware, in firmware, or in more specialized apparatus constructed to perform the method.

While the invention has been shown and described with reference to particular embodiments thereof, it will be understood by those skilled in the art that the foregoing and other changes in form and detail may be made therein without departing from the spirit and scope of the invention. The appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the appended claims may contain the introductory phrases “at least one” or “one or more” to introduce claim elements. However, the use of such phrases should not be construed to imply that the introduction of a claim element by indefinite articles such as “a” or “an” limits any particular claim containing such introduced claim element to inventions containing only one such element, even when the same claim includes the introductory phrases “at least one” or “one or more” and indefinite articles such as “a” or “an;” the same holds true for the use in the claims of definite articles.

We claim:

1. A method of quality assurance in a network environment, said method comprising:
providing a measurement process including (a)-(b) below:
(a) transmitting a test stream over a transmission path;
(b) measuring a quality-of-service indicator for a real-time communication application based on said transmitting;
utilizing said measurement process, in continuously sampling a plurality of transmission paths in said real-time communication application's production environment;
collecting data from said measurement process;
comparing measured values to a threshold value;
outputting a representation of compliance or non-compliance with said threshold value; and
outputting a trend report based on said data;
whereby said real-time communication application may be managed with reference to said threshold value.

2. The method of claim 1, wherein said sampling a plurality of transmission paths further comprises:
sampling a transmission path within a site; and
sampling a transmission path between sites.

3. The method of claim 1, further comprising:
utilizing said representation in managing the operation of said real-time communication application; and
comparing results for said transmission path within a site to results for said transmission path between sites.

4. The method of claim 3, further comprising:
setting a new threshold value; and
managing said real-time communication application with reference to said new threshold value.

5. The method of claim 1, wherein said real-time communication application is chosen from:
a Voice-over-Internet-Protocol application;
a video conference application; and
a speech-recognition application.

6. The method of claim 1, wherein said measuring a quality-of-service indicator further comprises one or more of the following:
utilizing perceptual evaluation of speech quality;
measuring transport delay; and
measuring packet loss.

7. The method of claim 1, wherein said measuring a quality-of-service indicator further comprises measuring:
an audio-quality indicator,
or a video-quality indicator,
or both.

8. The method of claim 1, wherein said transmitting a test stream further comprises transmitting a reference file.

9. The method of claim 1, further comprising:
calculating statistics, based on said data; and
outputting said statistics.

10. The method of claim 1, further comprising:
providing an alert via a system-management computer, when results of said comparing indicate an error.

11. A method of quality assurance in a network environment, said method comprising:
utilizing a measurement process including (a)-(d) below:
(a) transmitting a test stream over a call path in a voice-over-IP application's production environment;
(b) receiving said test stream;
(c) measuring a speech-quality indicator for said voice-over-IP application, based on said transmitting and receiving;
(d) repeating the above three steps periodically;
with said measurement process, sampling a call path within a site;
with said measurement process, sampling a call path between sites;
collecting data from said measurement process;
comparing results of said measuring to a threshold value; and
outputting a representation of compliance or non-compliance with said threshold value.

12. The method of claim 11, further comprising:
with said measurement process, sampling a plurality of call paths between sites; and outputting a representation of a plurality of call paths from a first site to other sites.

13. The method of claim 11, wherein:
said speech-quality indicator is a measurement of perceptual speech quality.

14. The method of claim 11, wherein said comparing results further comprises comparing results expressed as a mean opinion score, to a threshold value expressed as a mean opinion score.

15. The method of claim 11, further comprising:
utilizing said representation in managing the operation of said Voice-over-Internet-Protocol application.

16. The method of claim 11, further comprising:
utilizing said representation in evaluating new infrastructure components in said production environment.

17. The method of claim 11, further comprising:
receiving input specifying a call path of interest;
retrieving stored data associated with said call path of interest; and
comparing measured values to a unique threshold value, for said call path of interest;
whereby data mining and evaluation are performed for said call path of interest.

18. The method of claim 11, further comprising:
receiving input identifying a call path within a first site, and a call path within a second site;
retrieving stored data associated with said identified call paths; and
comparing measured values to a threshold value, for each of said identified call paths;
whereby data mining and evaluation are performed for said first site and said second site.

19. The method of claim 11, wherein said outputting a representation of non-compliance further comprises outputting said results in a special mode.

20. The method of claim 19, wherein said outputting in a special mode further comprises outputting in a special color.

21. The method of claim 20, wherein said special color is red.

22. A system of quality assurance in a network environment, said system comprising:
means for transmitting a test stream over a transmission path;
means for measuring a quality-of-service indicator for a real-time communication application based on said transmitting;
means for continuously sampling a plurality of transmission paths in said real-time communication application's production environment;
means for collecting data from said measurement process;
means for comparing measured values to a threshold value;
means for outputting a representation of compliance or non-compliance with said threshold value; and
means for outputting a trend report based on said data.

23. The system of claim 22, wherein said means for continuously sampling a plurality of transmission paths further comprises:
means for sampling a transmission path within a site; and
means for sampling a transmission path between sites.

24. The system of claim 22, further comprising:
means for adjusting said threshold value.

25. The system of claim 22, wherein said real-time communication application is chosen from:
a Voice-over-Internet-Protocol application;
a video conference application; and
a speech-recognition application.

26. The system of claim 22, wherein said means for measuring a quality-of-service indicator further comprises one or more of the following:
means for utilizing perceptual evaluation of speech quality;
means for measuring transport delay; and
means for measuring packet loss.

27. The system of claim 22, wherein said means for transmitting a test stream further comprises means for transmitting a reference file.

28. The system of claim 22, further comprising:
means for calculating statistics, based on said data; and
means for outputting said statistics.

29. The system of claim 22, further comprising:
means for providing an alert, to an end-to-end management site, via a system-management computer, when results of said comparing indicate an error.

30. The system of claim 22, further comprising data mining means for:
receiving input specifying a transmission path of interest;
retrieving stored data associated with said transmission path of interest; and
comparing measured values to a unique threshold value, for said transmission path of interest.

31. The system of claim 22, further comprising data mining means for:
receiving input identifying a transmission path within a first site, and a transmission path within a second site;
retrieving stored data associated with said identified transmission paths; and
comparing measured values to a threshold value, for each of said identified transmission paths.

32. A computer-usable medium having computer-executable instructions for quality assurance in a network environment, said computer-usable medium comprising:
means for continuously collecting data from a plurality of transmission paths in a real-time communication application's production environment, said data resulting from transmitting a test stream over a transmission path, and measuring a quality-of-service indicator for said real-time communication application;
means for comparing measured values to a threshold value;
means for outputting a representation of compliance or non-compliance with said threshold value; and
means for outputting a trend report based on said data.

33. The computer-usable medium of claim 32, wherein said means for continuously collecting data further comprises:
means for collecting data from a transmission path within a site; and
means for collecting data from a transmission path between sites.

34. The computer-usable medium of claim 32, further comprising:
means for adjusting said threshold value.

35. The computer-usable medium of claim 32, further comprising:
means for calculating statistics, based on said data; and
means for outputting said statistics.

36. The computer-usable medium of claim 32, further comprising:
means for providing an alert via a system-management computer, when results of said comparing indicate an error.

37. The computer-usable medium of claim 32, further comprising data mining means for:
receiving input specifying a transmission path of interest;
retrieving stored data associated with said transmission path of interest; and
comparing measured values to a unique threshold value, for said transmission path of interest.

38. The computer-usable medium of claim 32, further comprising data mining means for:
receiving input identifying a transmission path within a first site, and a transmission path within a second site;
retrieving stored data associated with said identified transmission paths; and
comparing measured values to a threshold value, for each of said identified transmission paths.
